(19) United States
(12) Patent Application Publication
(10) Pub. No.: US 2016/0237347 A1
(43) Pub. Date: Aug. 18, 2016

(54) NEMATIC LIQUID CRYSTAL COMPOSITION AND LIQUID CRYSTAL DISPLAY DEVICE USING THE SAME

(71) Applicant: DIC CORPORATION, Tokyo (JP)

(72) Inventors: Go Sudo, Kita-adachi-gun (JP); Shotaro Kawakami, Kita-adachi-gun (JP)

(73) Assignee: DIC CORPORATION, Tokyo (JP)

(21) Appl. No.: 14/787,139

(22) PCT Filed: Sep. 25, 2014
(86) PCT No.: PCT/JP2014/075483

§ 371 Date: Oct. 26, 2015

(30) Foreign Application Priority Data
Oct. 3, 2013 (JP) 2013-208201

(51) Int. Cl. C09K 19/30; G02F 1/1362; C09K 19/54

(52) U.S. Cl. CPC C09K 19/3066; C09K 19/3001; C09K 19/542; G02F 1/1362; C09K 2019/548

(57) ABSTRACT

Without reductions in refractive index anisotropy (Δn) and nematic phase-isotropic liquid phase transition temperature (Tₙᵢ), the liquid crystal composition has sufficiently low solid phase-nematic phase transition temperature (T_{cn}), sufficiently small viscosity (η), sufficiently small rotational viscosity (γ1), a large elastic constant (K₃₃), and negative dielectric anisotropy (Δ∈) with a large absolute value. The liquid crystal composition contains a first component that is a compound represented by Formula (N2), a second component that is at least one compound represented by General Formula (N3), and a third component that is at least one compound having a negative dielectric anisotropy (Δ∈) with an absolute value of greater than three. There is also provided a liquid crystal display device using such a liquid crystal composition.

### TECHNICAL FIELD

The present invention relates to a nematic liquid crystal composition which is useful as a material for a liquid crystal display and which has a negative dielectric anisotropy (Δ∈), and to a liquid crystal display device using such a nematic liquid crystal composition.

### BACKGROUND ART

Liquid crystal display devices are applied to, for example, watches, calculators, a variety of household electrical appliances, measuring equipment, panels used in automobiles, word processors, electronic notebooks, printers, computers, and television sets. Representative examples of types of liquid crystal display devices include a TN (twisted nematic) type, an STN (super twisted nematic) type, a DS (dynamic scattering) type, a GH (guest•host) type, an IPS (in-plane switching) type, an OCB (optically compensated birefringence) type, an ECB (electrically controlled birefringence) type, a VA (vertical alignment) type, a CSH (color super homeotropic) type, and an FLC (ferroelectric liquid crystal) type. Examples of a drive system include static driving, multiplex driving, a passive matrix, and an active matrix (AM) in which, for example, a TFT (thin film transistor) or a TFD (thin film diode) is used for driving.

Among these types of liquid crystal display devices, an IPS type, an ECB type, a VA type, and a CSH type are characterized in that a liquid crystal material having a negative Δ∈ is used. In particular, VA display devices of AM driving are applied to display devices that need to quickly respond and to have a wide viewing angle, such as television sets.

Nematic liquid crystal compositions used in VA display devices need to enable driving at low voltage, a quick response, and a broad range of operating temperature. In other words, a liquid crystal composition having a negative Δ∈ with a large absolute value, a low viscosity, and a high nematic phase-isotropic liquid phase transition temperature (Tₙᵢ) has been demanded. In order to control Δn×d that is a product of refractive index anisotropy (Δn) and a cell gap (d) to be a predetermined value, the Δn of a liquid crystal material needs to be adjusted to be in a proper range on the basis of the cell gap. In addition, a quick response is important in liquid crystal display devices applied to television sets or other apparatuses, which generates a need for a liquid crystal material having a small viscosity (η).

A variety of compounds having a negative Δ∈ with a large absolute value have been studied to improve the properties of liquid crystal compositions.

A liquid crystal composition containing the following liquid crystal compounds (A) and (B) each having a 2,3-difluorophenylene structure has been disclosed as a liquid crystal material having a negative Δ∈ (see Patent Literature 1).

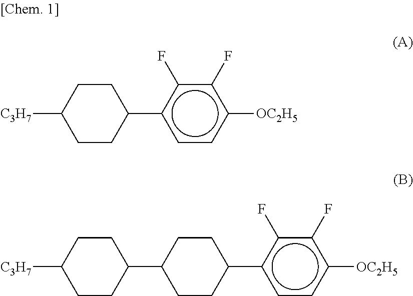

This liquid crystal composition also contains liquid crystal compounds (C) and (D) as compounds having a Δ∈ of substantially zero; however, the liquid crystal composition does not have a sufficiently low viscosity that is necessary in applications that need quick response, such as liquid crystal television sets.

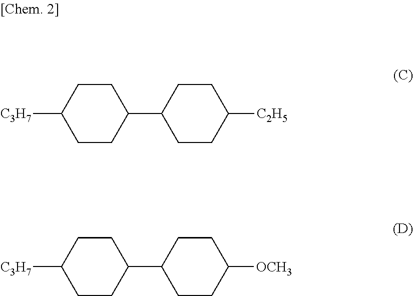

A liquid crystal composition containing a compound represented by Formula (E) has been disclosed; however, this composition is a liquid crystal composition in which the liquid crystal compound (D) is used in combination and which has a small Δn (see Patent Literature 2) or a liquid crystal composition which contains a compound of which the molecules each contain an alkenyl group (alkenyl compound), such as a liquid crystal compound (F), to improve response speed (see Patent Literature 3). Further study has been necessary in order to give both high Δn and high reliability.

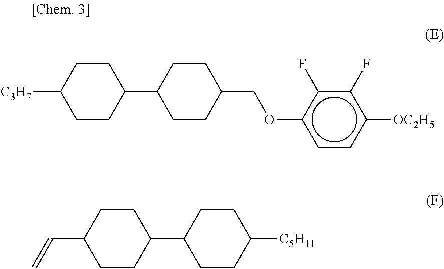

A liquid crystal composition containing a compound represented by Formula (G) has been disclosed (see Patent Literature 4), but this composition is also a liquid crystal composition containing an alkenyl compound such as the liquid crystal compound (F). Thus, the liquid crystal composition has a problem in which defective display such as screen burn-in and uneven display is likely to be caused.

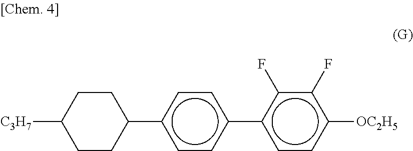

The effect of the liquid crystal composition containing an alkenyl compound on defective display has been disclosed (see Patent Literature 5). In general, a decrease in the alkenyl compound content leads to an increase in the η of a liquid crystal composition, and sufficiently quick response speed is therefore not produced; thus, both requirements of reduced defective display and quick response have not been satisfied at the same time.

Merely combining a compound having a negative Δ∈ with the liquid crystal compound (C), (D), or (F) as described above is not enough to produce a liquid crystal composition that has both high Δn and low η and a negative Δ∈ as well and that enables a reduction or elimination of defective display.

Another liquid crystal composition has been disclosed, in which the compounds represented by Formulae (A) and (G) are used in combination with a compound represented by Formula (III-F31) and having a Δ∈ of substantially zero (see Patent Literature 6). In a process for manufacturing a liquid crystal display device, however, a compound having a low vapor pressure volatilizes in an extremely low pressure environment on injection of a liquid crystal composition into a liquid crystal cell; hence, it is believed that the amount of such a compound cannot be increased. Thus, the liquid crystal composition contains a limited amount of the compound represented by Formula (III-F31) and has a large Δn while the viscosity is excessively high, which has been problematic.

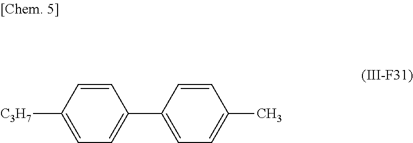

Furthermore, a liquid crystal composition containing a fluorine-substituted compound having a terphenyl structure has been disclosed in each of Patent Literatures 6 and 7. Moreover, another technique has been disclosed in Patent Literature 8, in which a liquid crystal material having a large index (FoM) represented by (Equation 1) is used to enhance the response speed of a homeotropic liquid crystal cell; however, the enhancement in the response speed of the liquid crystal composition, which has been described in Description thereof, is insufficient.

[Math. 1]

FoM=K³³·Δn²/γ1 (Equation 1)
K³³: Elastic constant
Δn: Refractive index anisotropy
γ1: Rotational viscosity

From such viewpoints, a liquid crystal composition that enables a quick response speed that is necessary in applications such as liquid crystal television sets needs to have the following properties without reductions in refractive index anisotropy (Δn) and nematic phase-isotropic liquid phase transition temperature (Tₙᵢ): sufficiently low solid phase-nematic phase transition temperature (T_{cn}), sufficiently small viscosity (η), sufficiently small rotational viscosity (γ1), and a large elastic constant (K₃₃).

### CITATION LIST

### Patent Literature

PTL 1: Japanese Unexamined Patent Application Publication No. 8-104869

PTL 2: European Patent Application Publication No. 0474062

PTL 3: Japanese Unexamined Patent Application Publication No. 2006-37054

PTL 4: Japanese Unexamined Patent Application Publication No. 2001-354967

PTL 5: Japanese Unexamined Patent Application Publication No. 2008-144135

PTL 6: WO 2007/077872

PTL 7: Japanese Unexamined Patent Application Publication No. 2003-327965

PTL 8: Japanese Unexamined Patent Application Publication No. 2006-301643

### SUMMARY OF INVENTION

### Technical Problem

A problem to be solved by the present invention is to provide a liquid crystal composition having the following properties without reductions in refractive index anisotropy (Δn) and nematic phase-isotropic liquid phase transition temperature (Tₙᵢ): sufficiently low solid phase-nematic phase transition temperature (T_{cn}) sufficiently small viscosity (η), sufficiently small rotational viscosity (γ1), a large elastic constant (K₃₃), and a negative dielectric anisotropy (Δ∈) with a large absolute value. Another problem to be solved by the present invention is to provide a liquid crystal display device of, for example, a VA type that uses such a liquid crystal composition and that has a high response speed and excellent display quality with defective display being eliminated or reduced.

### Solution to Problem

The inventors have studied a variety of bicyclohexyl derivatives and cyclohexylbiphenyl derivatives and found that a combination of specific compounds solves the above-mentioned problems, thereby accomplishing the present invention.

The present invention provides a liquid crystal composition containing a first component that is a compound represented by Formula (N2)

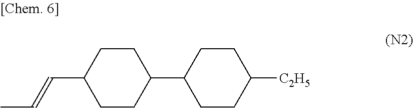 [SMILES: C/C=C/C1CCC(C2CCC(CC)CC2)CC1]

a second component that is at least one compound represented by General Formula (N3)

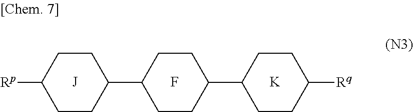

(where R^{p} and R^{q} each represent an alkyl group having 1 to 10 carbon atoms, an alkoxyl group having 1 to 10 carbon atoms, an alkenyl group having 2 to 10 carbon atoms, or an alkenyloxy group having 2 to 10 carbon atoms of which a —CH₂— or at least two —CH₂— not adjoining each other are each independently optionally substituted with —O— or —S— and of which one or more hydrogen atoms are each independently optionally substituted with a fluorine atom or a chlorine atom; a ring J represents a trans-1,4-cyclohexylene group, a 1,4-phenylene group, a 2-fluoro-1,4-phenylene group, a 3-fluoro-1,4-phenylene group, a 3,5-difluoro-1,4-phenylene group, a 2,3-difluoro-1,4-phenylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2,6-diyl group; and rings F and K each represent a 1,4-phenylene group of which a hydrogen atom is optionally substituted with a fluorine atom), and a third component that is at least one compound having a negative dielectric anisotropy (Δ∈) with an absolute value of greater than three. The present invention also provides a liquid crystal display device using such a liquid crystal composition.

### Advantageous Effects of Invention

The liquid crystal composition of the present invention retains sufficiently low solid phase-nematic phase transition temperature (T_{cn}) sufficiently small viscosity (η), sufficiently small rotational viscosity (γ1), a large elastic constant (K₃₃), a high voltage holding ratio (VHR), and negative dielectric anisotropy (Δ∈) with a large absolute value without reductions in refractive index anisotropy (Δn) and nematic phase-isotropic liquid phase transition temperature (Tₙᵢ); hence, a liquid crystal display device of, for instance, a VA type, which uses such a liquid crystal composition, has a quick response speed and excellent display quality with defective display being eliminated or reduced.

### DESCRIPTION OF EMBODIMENTS

The liquid crystal composition of the present invention contains 3 to 40 mass % of a first component; and the amount is preferably in the range of 5 to 35 mass %, more preferably 5 to 30 mass %, and especially preferably 10 to 30 mass %. In particular, in order to give small viscosity or rotational viscosity, the amount is preferably in the range of 20 to 40 mass %; in the case of focusing on a reduction in precipitation at low temperature, the amount is preferably in the range of 5 to 30 mass %, more preferably 5 to 25 mass %, and especially preferably 5 to 20 mass %.

The liquid crystal composition contains 3 to 40 mass % of a second component; and the amount is preferably in the range of 5 to 30 mass %, more preferably 5 to 20 mass %, and especially preferably 10 to 20 mass %. In particular, in order to give large Δn and Tni, the amount is preferably in the range of 15 to 40 mass %; in the case of focusing on a reduction in precipitation at low temperature, the amount is preferably in the range of 5 to 15 mass %. At least one compound is used as the second component; it is preferred that 1 to 10 compounds be used, and it is more preferred that 1 to 5 compounds be used.

The second component is a compound represented by General Formula (N3).

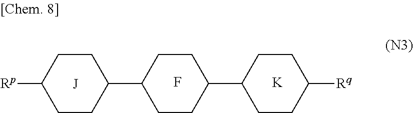

In the formula, R^{p} and R^{q} each independently represent an alkyl group having 1 to 10 carbon atoms, an alkoxyl group having 1 to 10 carbon atoms, an alkenyl group having 2 to 10 carbon atoms, or an alkenyloxy group having 2 to 10 carbon atoms; and preferably an alkyl group having 1 to 5 carbon atoms, an alkoxyl group having 1 to 5 carbon atoms, an alkenyl group having 2 to 5 carbon atoms, or an alkenyloxy group having 2 to 5 carbon atoms; one —CH₂— or at least two —CH₂— not adjoining each other of these groups are each independently optionally substituted with —O— or —S—, and one or more hydrogen atoms of the groups are each independently optionally substituted with a fluorine atom or a chlorine atom. The ring J represents a trans-1,4-cyclohexylene group, a 1,4-phenylene group, a 2-fluoro-1,4-phenylene group, a 3-fluoro-1,4-phenylene group, a 3,5-difluoro-1,4-phenylene group, a 2,3-difluoro-1,4-phenylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2,6-diyl group. The rings F and K each represent a 1,4-phenylene group of which a hydrogen atom is optionally substituted with a fluorine atom.

R^{p} is more preferably an alkyl group having 1 to 5 carbon atoms or an alkenyl group having 2 to 5 carbon atoms, and especially preferably a linear alkyl group having 1 to 5 carbon atoms or a linear alkenyl group having 2 to 5 carbon atoms.

R^{q} is more preferably an alkyl group having 1 to 5 carbon atoms, an alkoxyl group having 1 to 5 carbon atoms, an alkenyl group having 2 to 5 carbon atoms, or an alkenyloxy group having 2 to 5 carbon atoms; and especially preferably a linear alkyl group having 1 to 5 carbon atoms, a linear alkoxyl group having 1 to 5 carbon atoms, or a linear alkenyl group having 2 to 5 carbon atoms.
The ring J is preferably a trans-1,4-cyclohexylene group, a 1,4-phenylene group, a 2-fluoro-1,4-phenylene group, a 3-fluoro-1,4-phenylene group, a 3,5-difluoro-1,4-phenylene group, a 2,3-difluoro-1,4-phenylene group; more preferably a trans-1,4-cyclohexylene group, a 1,4-phenylene group, a 2-fluoro-1,4-phenylene group, or a 3-fluoro-1,4-phenylene group; and especially preferably a trans-1,4-cyclohexylene group or a 1,4-phenylene group.
The rings F and K each represent a 1,4-phenylene group of which a hydrogen atom is optionally substituted or unsubstituted with a fluorine atom.

In particular, a compound represented by General Formula (N3-3) or (N3-4) is preferred, and the compound represented by General Formula (N3-3) is more preferred.

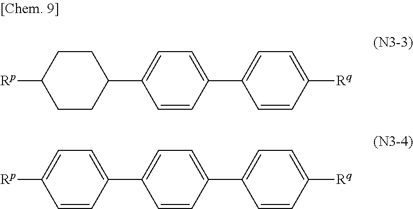

R^{p} and R^{q} in each of the formulae have the same meanings as described above.

The compound represented by General Formula (N3-3) is preferably a compound represented by General Formula (N3-a).

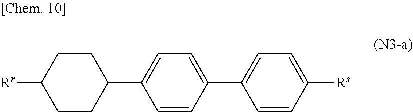

In the formula, R^{r} and R^{s} each independently represent an alkyl group having 1 to 5 carbon atoms, an alkoxyl group having 1 to 5 carbon atoms, an alkenyl group having 2 to 5 carbon atoms, or an alkenyloxy group having 2 to 5 carbon atoms; R^{r} is especially preferably an alkyl group having 1 to 5 carbon atoms or an alkenyl group having 2 to 5 carbon atoms, and R^{s} is especially preferably an alkyl group having 1 to 5 carbon atoms. These groups are more preferably linear. One —CH₂— or at least two —CH₂— not adjoining each other of these groups are each independently optionally substituted with —O— or —S—, and one or more hydrogen atoms of the groups are each independently optionally substituted with a fluorine atom or a chlorine atom.

Specifically, the compound represented by General Formula (N3-a) is preferably any of compounds represented by General Formula (N3-a1) to (N3-a8).

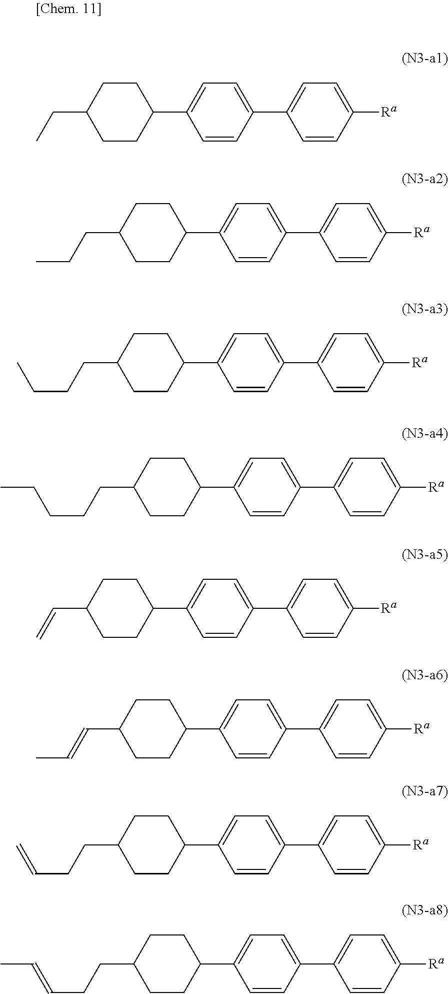

In the formulae, R^{a} has the same meaning as R^{s}.

The composition contains a third component that is at least one compound having a negative Δ∈ with an absolute value of greater than three; it is preferred that 1 to 15 compounds be used, it is more preferred that 1 to 10 compounds be used, and it is especially preferred that 2 to 10 compounds be used. The amount of the third component is preferably in the range of 10 to 90 mass %, more preferably 20 to 80 mass %, and especially preferably 30 to 70 mass %.

The third component is preferably a compound represented by General Formula (II).

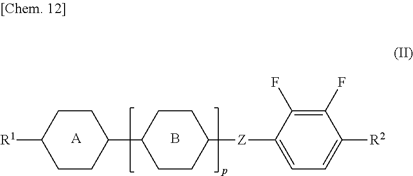

In the formula, R¹ and R² each independently represent an alkyl group having 1 to 10 carbon atoms, an alkoxyl group having 1 to 10 carbon atoms, an alkenyl group having 2 to 10 carbon atoms, or an alkenyloxy group having 2 to 10 carbon atoms; one —CH₂— or at least two —CH₂— not adjoining each other of these groups are each independently optionally substituted with —O— or —S—, and one or more hydrogen atoms of the groups are each independently optionally substituted with a fluorine atom or a chlorine atom. The rings A and B each independently represent a trans-1,4-cyclohexylene group, a 1,4-phenylene group, a 2-fluoro-1,4-phenylene group, a 3-fluoro-1,4-phenylene group, a 3,5-difluoro-1,4-phenylene group, a 2,3-difluoro-1,4-phenylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2,6-diyl group. p represents 0, 1, or 2; in the case where p represents 2, the two rings B may be the same as or different from each other. Z represents —OCH₂—, —CH₂O—, —CF₂O—, —OCF₂—, —CH₂CH₂—, —CF₂CF₂—, or a single bond.

In the formula, R¹ and R² each independently preferably represent an alkyl group having 1 to 5 carbon atoms, an alkoxyl group having 1 to 5 carbon atoms, an alkenyl group having 2 to 5 carbon atoms, or an alkenyloxy group having 2 to 5 carbon atoms; R¹ is especially preferably an alkyl group having 1 to 5 carbon atoms or an alkenyl group having 2 to 5 carbon atoms, and R² is especially preferably an alkyl group having 1 to 5 carbon atoms. These groups are also preferably linear.

In the formula, the rings A and B are each independently preferably a trans-1,4-cyclohexylene group, a 1,4-phenylene group, a 2-fluoro-1,4-phenylene group, a 3-fluoro-1,4-phenylene group, a 3,5-difluoro-1,4-phenylene group, or a 2,3-difluoro-1,4-phenylene group; and especially preferably a trans-1,4-cyclohexylene group or a 1,4-phenylene group. A —CH₂— of each of the rings is optionally substituted with —O—.

In the formula, p is preferably 0 or 1.

In the formula, Z is preferably —CH₂O—, —CF₂O—, —CH₂CH₂—, or a single bond; and especially preferably —CH₂O— or a single bond.

The compound represented by General Formula (II) is preferably any of compounds represented by General Formulae (II-A1) to (II-A5) and (II-B1) to (II-B5); among these, any of compounds represented by General Formulae (II-A1) to (II-A5) is preferred, and any of compounds represented by General Formulae (II-A1) and (II-A3) is especially preferred.

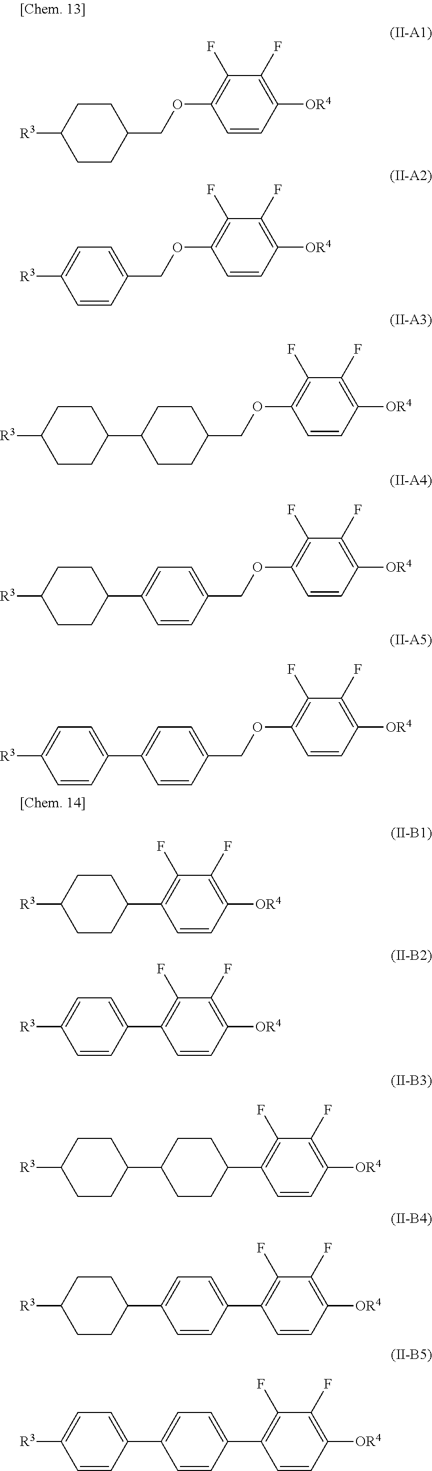

In the formulae, R³ and R⁴ each independently represent an alkyl group having 1 to 5 carbon atoms or an alkenyl group having 2 to 5 carbon atoms; one —CH₂— or at least two —CH₂— not adjoining each other of these groups are each independently optionally substituted with —O— or —S—. One or more hydrogen atoms of the groups are each independently optionally substituted with a fluorine atom.

The liquid crystal composition of the present invention contains a fourth component that is at least one compound selected from the group consisting of compounds represented by General Formulae (IV-1) to (IV-5); it is preferred that 1 to 10 compounds be used, and it is more preferred that 1 to 5 compounds be used. The total amount thereof is preferably in the range of 5 to 70 mass %, more preferably 10 to 60 mass %, and especially preferably 20 to 60 mass %.

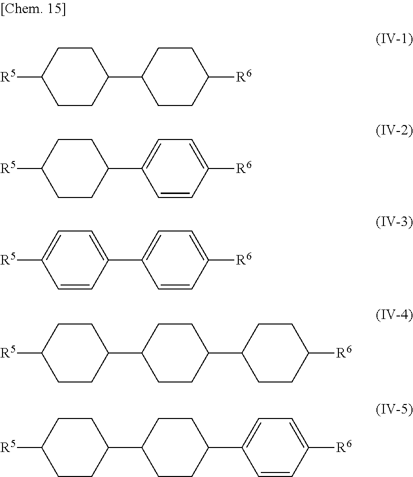

In the formulae, R⁵ represents an alkyl group having 1 to 5 carbon atoms or an alkenyl group having 2 to 5 carbon atoms; and R⁶ represents an alkyl group having 1 to 5 carbon atoms, an alkoxyl group having 1 to 5 carbon atoms, an alkenyl group having 2 to 5 carbon atoms, or an alkenyloxy group having 2 to 5 carbon atoms. One —CH₂— or at least two —CH₂— not adjoining each other of these groups are each independently optionally substituted with —O— or —S—, and one or more hydrogen atoms of the groups are each independently optionally substituted with a fluorine atom. The compound represented by General Formula (IV-1) excludes compounds corresponding to the compound represented by Formula (N2).

The fourth component is preferably a compound selected from the compounds represented by General Formulae (IV-1), (IV-3), and (IV-5). In the compound represented by General Formula (IV-1), R⁵ is preferably an alkenyl group having 2 or 3 carbon atoms, and R⁶ is preferably an alkyl group having 3 to 5 carbon atoms or an alkenyl group having 2 to 5 carbon atoms.
The total amount of the first to fourth components in the liquid crystal composition of the present invention is from 80% to 100%, preferably 85% to 100%, more preferably 90% to 100%, and especially preferably 95% to 100%.
The liquid crystal composition of the present invention preferably contains a combination of the compounds represented by Formulae (N2) and (N3) and General Formulae (II-A1) and (IV-1), a combination of the compounds represented by Formulae (N2) and (N3) and General Formulae (II-A3) and (IV-1), a combination of the compounds represented by Formulae (N2) and (N3) and General Formulae (II-B1) and (IV-1), a combination of the compounds represented by Formulae (N2) and (N3) and General Formulae (II-B2) and (IV-1), a combination of the compounds represented by Formulae (N2) and (N3) and General Formulae (II-B3) and (IV-1), or a combination of the compounds represented by Formulae (N2) and (N3) and General Formulae (II-B4) and (IV-1); more preferably a combination of the compounds represented by Formulae (N2) and (N3) and General Formulae (II-A1) and (IV-1) or a combination of the compounds represented by Formulae (N2) and (N3) and General Formulae (II-A3) and (IV-1); and especially preferably a combination of the compounds represented by Formulae (N2) and (N3) and General Formulae (II-A1), (II-A3), and (IV-1). The liquid crystal composition also especially preferably contains a combination of the compounds represented by Formulae (N2) and (N3) and General Formulae (II-B2), (II-A3), and (IV-1) or a combination of the compounds represented by Formulae (N2) and (N3) and General Formulae (II-B2), (II-A5), and (IV-1). In addition to such preferred combinations, the liquid crystal composition preferably further contains a compound represented by General Formula (V).

It is preferred that at least one compound represented by General Formula (V) be used as an additional component; and the amount thereof is preferably in the range of 2 to 30 mass %, more preferably 2 to 25 mass %, and especially preferably 3 to 20 mass %.

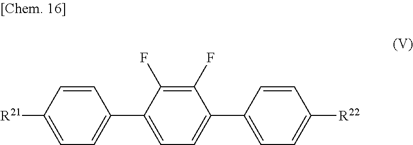

In the formula, R²¹ and R²² each independently represent an alkyl group having 1 to 8 carbon atoms, an alkoxyl group having 1 to 8 carbon atoms, an alkenyl group having 2 to 8 carbon atoms, or an alkenyloxy group having 2 to 8 carbon atoms; and preferably an alkyl group having 1 to 5 carbon atoms or an alkenyl group having 2 to 5 carbon atoms. One —CH₂— or at least two —CH₂— not adjoining each other of these groups are each independently optionally substituted with —O— or —S—, and one or more hydrogen atoms of the groups are each independently optionally substituted with a fluorine atom.

The compound represented by General Formula (V) is preferably any of compounds having the following structures.

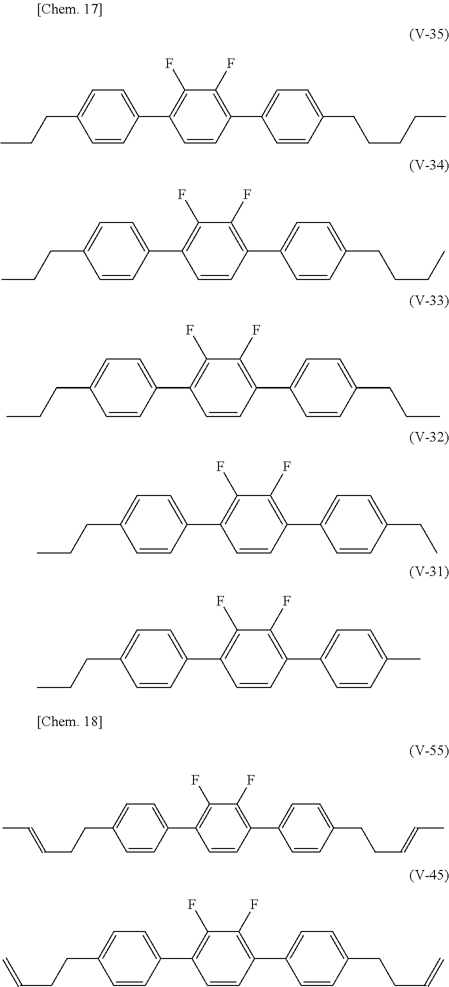

Any of the compounds represented by Formulae (V-32), (V-55), and (V-45) is more preferably employed. In the liquid crystal composition of the present invention, the total amount of the first to fourth components and the compound represented by General Formula (V) is from 80% to 100%, preferably 85% to 100%, more preferably 90% to 100%, and especially preferably 95% to 100%.

The dielectric anisotropy (Δ∈) of the liquid crystal composition of the present invention at 25° C. is from −2.0 to −8.0, preferably −2.0 to −6.0, more preferably −2.0 to −5.0, and especially preferably −2.5 to −4.0.

The refractive index anisotropy (Δn) of the liquid crystal composition of the present invention at 20° C. is from 0.08 to 0.14, preferably 0.09 to 0.13, and especially preferably 0.09 to 0.12. More specifically, the refractive index anisotropy is preferably from 0.10 to 0.13 for a thin cell gap or preferably from 0.08 to 0.10 for a thick cell gap.

The viscosity (η) of the liquid crystal composition of the present invention at 20° C. is from 10 to 30 mPa·S, preferably 10 to 25 mPa·S, and especially preferably 10 to 22 mPa·S.

The rotational viscosity (γ₁) of the liquid crystal composition of the present invention at 20° C. is from 60 to 130 mPa·S, preferably 60 to 110 mPa·S, and especially preferably 60 to 100 mPa·S.

The nematic phase-isotropic liquid phase transition temperature (Tₙᵢ) of the liquid crystal composition of the present invention is from 60° C. to 120° C., more preferably 70° C. to 100° C., and especially preferably 70° C. to 85° C.

The solid phase-nematic phase transition temperature (T_{cn}) of the liquid crystal composition of the present invention is −20° C. or lower, preferably −25° C. or lower, more preferably −30° C. or lower, and especially preferably −35° C. or lower.

The elastic constant (K₃₃) of the liquid crystal composition of the present invention is not less than 12.5, preferably not less than 13.0, more preferably not less than 13.5, and especially preferably not less than 14.0.

In addition to the above-mentioned compounds, the liquid crystal composition of the present invention may contain, for example, general nematic liquid crystal, smectic liquid crystal, cholesteric liquid crystal, antioxidants, ultraviolet absorbers, and polymerizable monomers.

The liquid crystal composition, for example, preferably contains 0.01 to 2 mass % of a polymerizable monomer that is a polymerizable compound such as a biphenyl derivative or a terphenyl derivative.

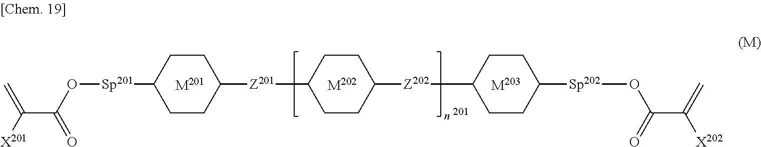

In particular, the liquid crystal composition of the present invention contains at least one of polymerizable compounds represented by General Formula (M).

In General Formula (M), X²⁰¹ and X²⁰² each independently represent a hydrogen atom, a methyl group, or a —CF₃ group. Diacrylate derivatives in which X²⁰¹ and X²⁰² each represent a hydrogen atom and dimethacrylate derivatives in which X²⁰¹ and X²⁰² are each a methyl group are preferred, and compounds in which one of X²⁰¹ and X²⁰² represents a hydrogen atom and in which the other one thereof represents a methyl group are also preferred. A suitable compound can be employed depending on applications; in PSA display devices, at least one of the methacrylate derivatives is preferably used as the polymerizable compound represented by General Formula (M), and at least two of the same are also preferably used.

Sp²⁰¹ and Sp²⁰² each independently represent a single bond, an alkylene group having 1 to 8 carbon atoms, or —O—(CH₂)ₛ— (where s represents an integer from 2 to 7, and the oxygen atom is bonded to a ring). In PSA liquid crystal display devices, at least one of Sp²⁰¹ and Sp²⁰² is preferably a single bond, and compounds in which Sp²⁰¹ and Sp²⁰² each represent a single bond and compounds in which one of Sp²⁰¹ and Sp²⁰² is a single bond and in which the other one thereof represents an alkylene group having 1 to 8 carbon atoms or —O—(CH₂)ₛ— are preferred. In this case, an alkylene group having 1 to 4 carbon atoms is preferably employed, and s preferably ranges from 1 to 4.

The rings M²⁰¹, M²⁰², and M²⁰³ each independently represent a trans-1,4-cyclohexylene group (of which one —CH₂— or at least two —CH₂— not adjoining each other are optionally substituted with —O— or —S—), a 1,4-phenylene group (of which one —CH═ or at least two —CH═ not adjoining each other are optionally substituted with —N═), a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2,6-diyl group; independently in each of these groups, a hydrogen atom is optionally substituted with a fluorine atom, a —CF₃ group, an alkyl group having 1 to 10 carbon atoms, an alkoxyl group having 1 to 10 carbon atoms, or any of the following structures represented by Formulae (R-1) to (R-15).

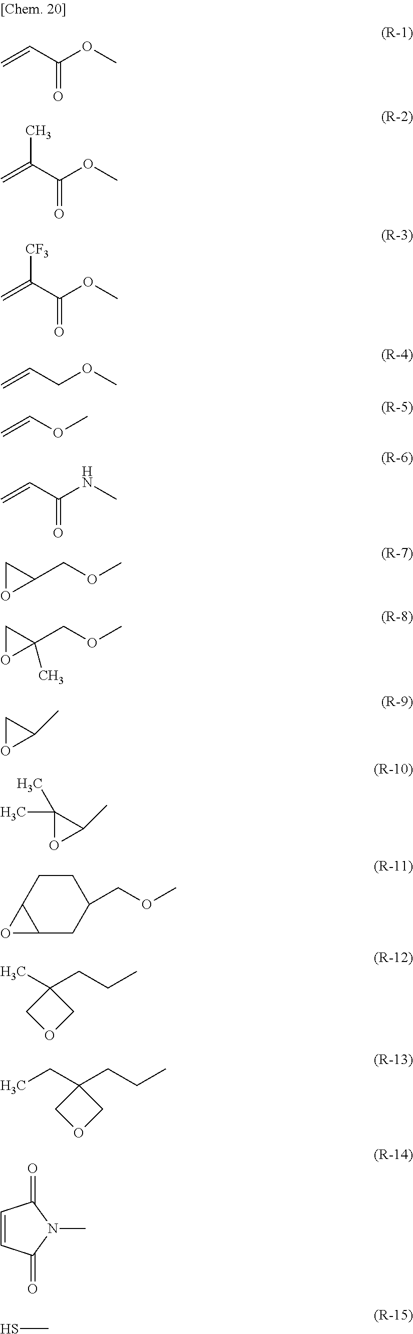

Z²⁰¹ and Z²⁰² each independently represent —OCH₂—, —CH₂O—, —COO—, —OCO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CY¹═CY²— (where Y¹ and Y² each independently represent a fluorine atom or a hydrogen atom), —C≡C—, or a single bond; preferably —COO—, —OCO—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, or a single bond; and more preferably —COO—, —OCO—, —CH═CH—OCO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, or a single bond.

n²⁰¹ represents 0, 1, or 2; and preferably 0 or 1. In the case where the ring M²⁰² and Z²⁰² are multiple, the multiple rings M²⁰² may be the same as or different from each other, and the Z²⁰²'s may be the same as or different from each other.

The polymerizable-compound-containing liquid crystal composition of the present invention contains at least one of polymerizable compounds represented by General Formula (M), preferably one to five, and more preferably one to three thereof. Insufficiency in the amount of the polymerizable compound represented by General Formula (M) results in weak alignment regulating force that affects the liquid crystal composition. Excess in the amount of the polymerizable compound represented by General Formula (M) enhances necessary energy for polymerization and therefore increases the amount of the polymerizable compound that remains without being polymerized, which causes defective display. Thus, the amount is preferably in the range of 0.01 to 2.00 mass %, more preferably 0.05 to 1.00 mass %, and especially preferably 0.10 to 0.50 mass %.

More specifically, in the case where n²⁰¹ in General Formula (M) is 0, the ring structure between Sp²⁰¹ and Sp²⁰² is preferably any of the following structures represented by Formulae (XXa-1) to (XXa-5), more preferably any of the structures represented by Formulae (XXa-1) to (XXa-3), and especially preferably any of the structures represented by Formulae (XXa-1) and (XXa-2). The two ends of each structure are bonded to Sp²⁰¹ and Sp²⁰², respectively.

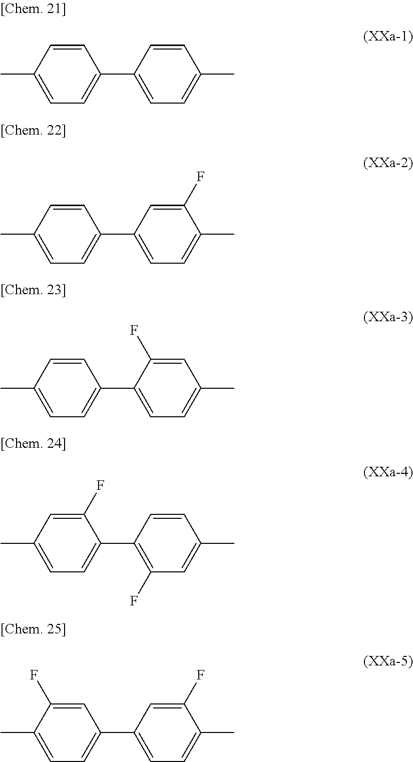

Polymerizable compounds represented by General Formula (M) and having such skeletons enable uneven display to be reduced or eliminated in PSA liquid crystal display devices because such polymerizable compounds have optimum alignment regulating force after being polymerized and thus produce a good alignment state.

Accordingly, the polymerizable monomer is preferably any of compounds represented by Formula (XX-1) to General Formula (XX-10), and more preferably any of compounds represented by Formulae (XX-1) to (XX-4).

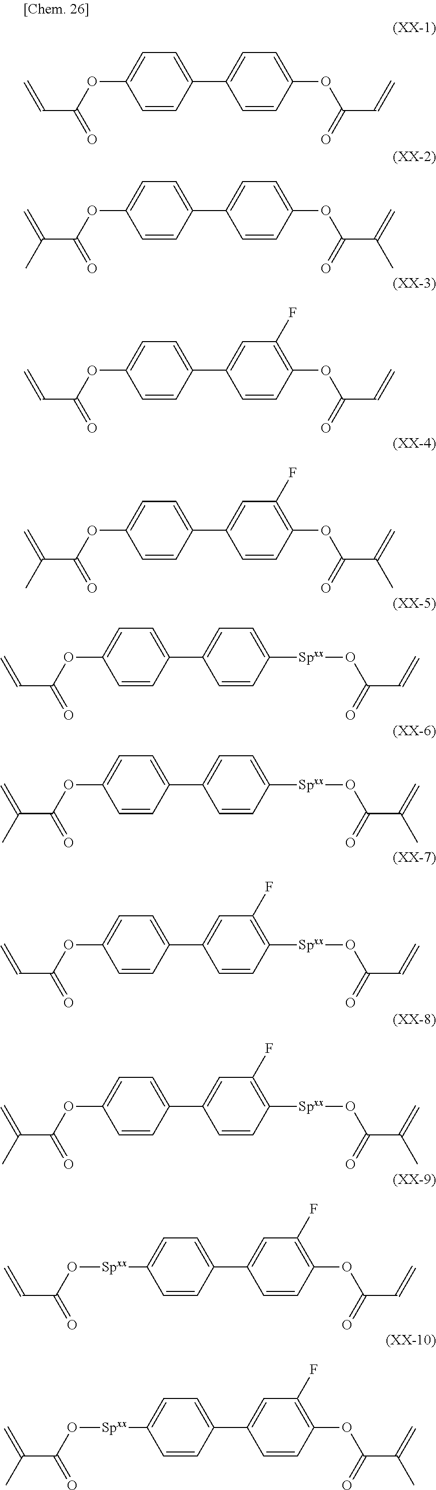

In the formulae, Sp^{xx} represents an alkylene group having 1 to 8 carbon atoms or —O—(CH₂)ₛ— (where s represents an integer from 2 to 7, and the oxygen atom is bonded to a ring).

In each of the formulae, a hydrogen atom is optionally substituted with —F, —Cl, —CF₃, —CH₃, or any of the structures represented by Formulae (R-1) to (R-15).

In the case where n²⁰¹ in General Formula (M) is 1, polymerizable compounds represented by, for instance, Formulae (M31) to (M48) are preferred.

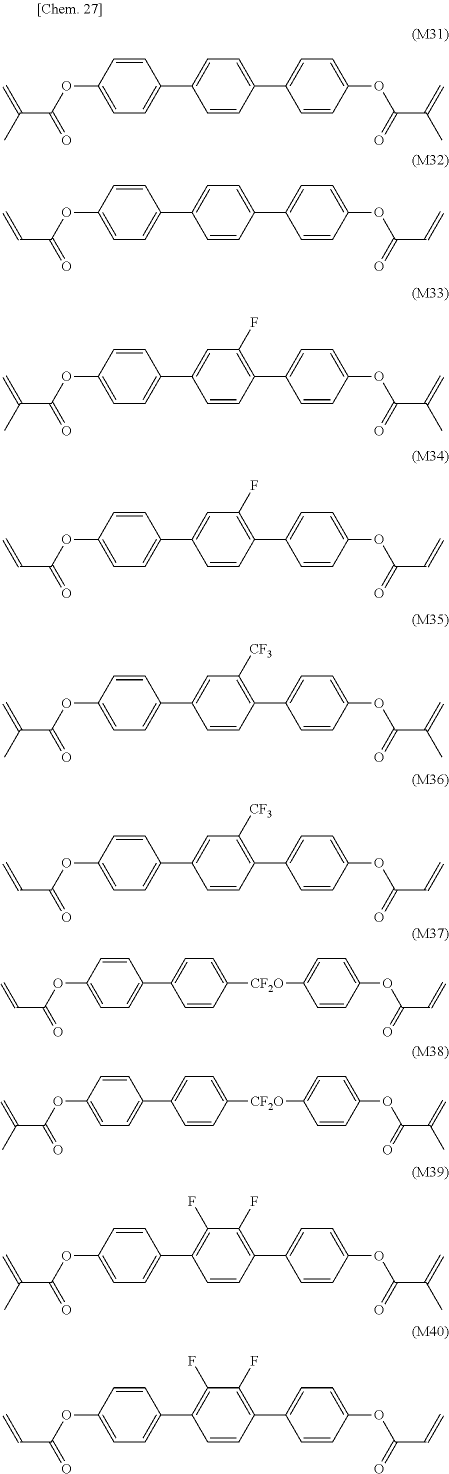

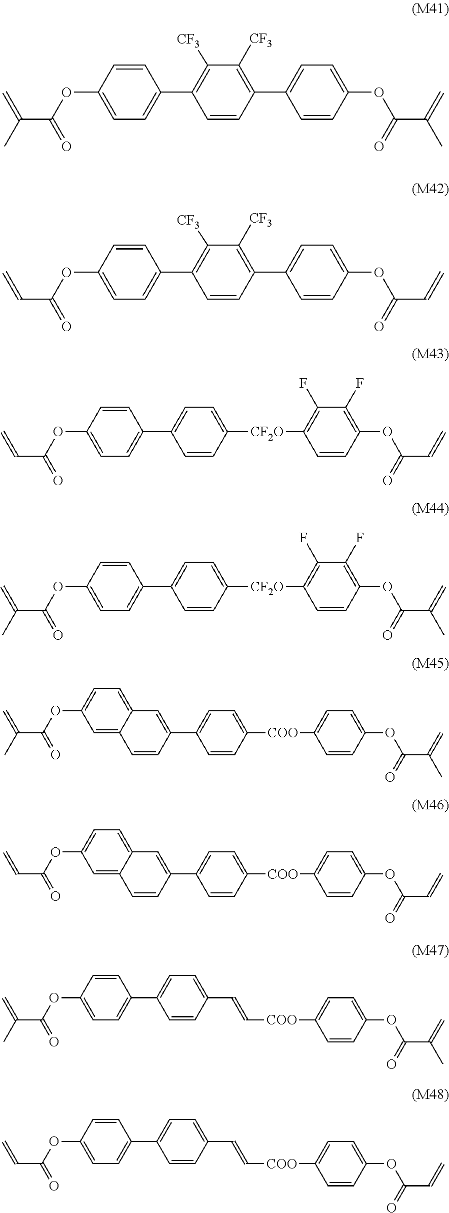

In each of the formulae, hydrogen atoms of a phenyl group and naphthalene group are optionally substituted with —F, —Cl, —CF₃, —CH₃, or any of the structures represented by Formulae (R-1) to (R-15).

Polymerizable compounds represented by General Formula (M) and having such skeletons enable uneven display to be reduced or eliminated in PSA liquid crystal display devices because such polymerizable compounds have optimum alignment regulating force after being polymerized and thus produce a good alignment state.

In the case where n²⁰¹ in General Formula (M) is 1 and where multiple structures represented by Formula (R-1) or (R-2) are present, polymerizable compounds represented by, for example, Formulae (M301) to (M316) are preferred.

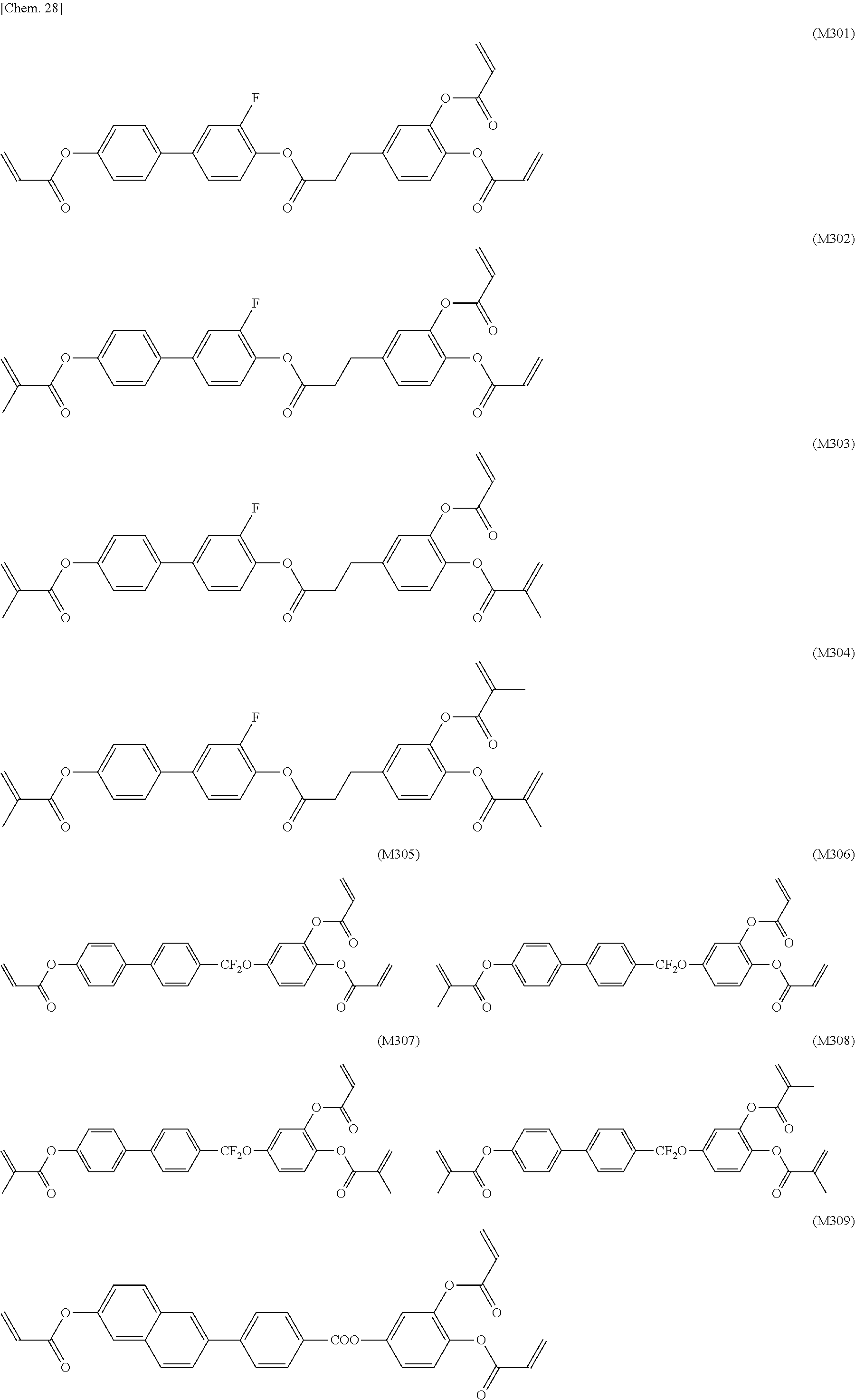

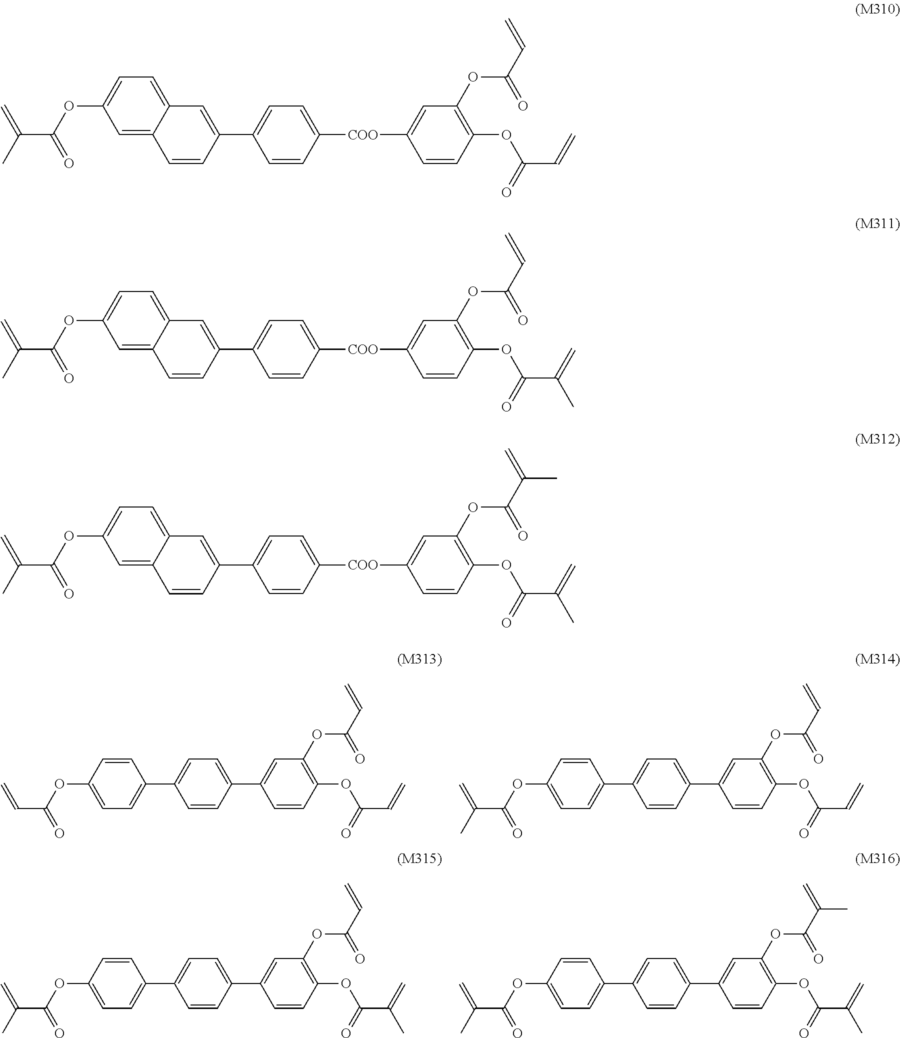

In each of the formulae, hydrogen atoms of a phenyl group and naphthalene group are optionally substituted with —F, —Cl, —CF₃, or —CH₃.

Polymerizable compounds represented by General Formula (M) and having such skeletons enable uneven display to be reduced or eliminated in PSA liquid crystal display devices because such polymerizable compounds have optimum alignment regulating force after being polymerized and thus produce a good alignment state.

The polymerizable-compound-containing liquid crystal composition in which the polymerizable compound represented by General Formula (M) has been added to the liquid crystal composition of the present invention has a low viscosity (η), low rotational viscosity (γ₁), and a large elastic constant (K₃₃); hence, PSA or PSVA liquid crystal display devices using such a composition can satisfy both requirements of reduced uneven display and quick response at the same time.

The liquid crystal display device using the liquid crystal composition of the present invention is particularly characterized in high response speed; in particular, it is useful as an active-matrix liquid crystal display device and can be applied to a VA mode, a PSVA mode, a PSA mode, an IPS mode, and an ECB mode.

### EXAMPLES

Although the present invention will now be described further in detail with reference to Examples, the present invention is not limited thereto. In compositions which will be described in Examples and Comparative Examples, the term “%” refers to “mass %”.

In Examples, compounds are abbreviated as follows.

### (Side Chains)

-n —CₙH₂ₙ₊₁ linear alkyl group having n carbon atoms
n- CₙH₂ₙ₊₁— linear alkyl group having n carbon atoms
—On —OCₙH₂ₙ₊₁ linear alkoxyl group having n carbon atoms
nO— CₙH₂ₙ₊₁O— linear alkoxyl group having n carbon atoms

### —V —CH═CH₂

### V— CH₂═CH—

### —V1 —CH═CH—CH₃

### 1V— CH₃—CH═CH—

-2V —CH₂—CH₂—CH═CH₃
V2— CH₃═CH—CH₂—CH₂—
-2V1 —CH₂—CH₂—CH═CH—CH₃
1V2- CH₃—CH═CH—CH₂—CH₂

### (Linking Groups)

-nO— —CₙH₂ₙO— linear linking group having n carbon atoms

### (Ring Structures)

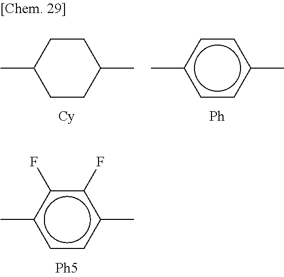

In Examples, the following properties were measured.

Tₙᵢ: Nematic phase-isotropic liquid phase transition temperature (° C.)

T_{cn}: Solid phase-nematic phase transition temperature (° C.)

Δn: Refractive index anisotropy at 20° C.

Δ∈: Dielectric anisotropy at 25° C.

η: Viscosity at 20° C. (mPa·s)

γ₁: Rotational viscosity at 20° C. (mPa·s)

K₃₃: Elastic constant K₃₃ at 20° C. (pN)

VHR (UV): Voltage holding ratio (VHR) after exposure to UV at 10 J

### Comparative Example 1 and Examples 1 to 3

Liquid crystal compositions LC-A (Comparative Example 1), LC-1 (Example 1), LC-2 (Example 2), and LC-3 (Example 3) were prepared; and the physical properties thereof were measured. Table 1 shows the components and physical properties of the liquid crystal compositions.

TABLE 1

| | | Comparative | | | |
|---|---|---|---|---|---|
| | | Example 1 | Example 1 | Example 2 | Example 3 |
| | | LC-A | LC-1 | LC-2 | LC-3 |
| 2-Cy-Cy-V1 | Formula (N2) | | 19 | 10 | 25 |
| 3-Cy-Ph-Ph-2 | General Formula (N3) | | 6 | 6 | 4 |
| 5-Cy-Ph-Ph-2 | General Formula (N3) | | 7 | 7 | 4 |
| V-Cy-Ph-Ph-3 | General Formula (N3) | | 7 | 7 | 6 |
| 1V-Cy-Ph-Ph-1 | General Formula (N3) | | | | 6 |
| 3-Cy-1O-Ph5-O1 | General Formula (II-A1) | | | 5 | 5 |
| 3-Cy-1O-Ph5-O2 | General Formula (II-A1) | 4 | 12 | 9 | 11 |
| 1V-Cy-1O-Ph5-O2 | General Formula (II-A1) | 13 | 13 | 7 | 8 |
| 2-Cy-Cy-1O-Ph5-O2 | General Formula (II-A3) | 4 | | 5 | |
| 3-Cy-Cy-1O-Ph5-O2 | General Formula (II-A3) | 5 | | 5 | |
| V-Cy-Cy-1O-Ph5-O2 | General Formula (II-A3) | | 3 | | 3 |
| 1V-Cy-Cy-1O-Ph5-O2 | General Formula (II-A3) | 13 | 10 | 7 | 4 |
| 3-Ph-Ph5-O2 | General Formula (II-B2) | | | | 5 |
| 3-Cy-Ph-Ph5-O2 | General Formula (II-B4) | | | | 6 |
| 3-Cy-Cy-V | General Formula (IV-1) | 6 | 12 | 19 | 7 |
| 3-Cy-Cy-V1 | General Formula (IV-1) | 6 | 8 | 5 | |
| 3-Cy-Cy-2 | General Formula (IV-1) | 14 | | | |
| 3-Ph-Ph-1 | General Formula (IV-3) | | | 4 | |
| 5-Ph-Ph-1 | General Formula (IV-3) | 15 | | | |
| 3-Cy-Cy-Ph-1 | General Formula (IV-5) | 9 | | | |
| 3-Cy-Cy-Ph-3 | General Formula (IV-5) | 8 | | | |
| 3-Ph-Ph5-Ph-2 | General Formula (V) | 3 | 3 | | 3 |
| 1V2-Ph-Ph5-Ph-2V1 | General Formula (V-55) | | | 4 | 3 |

| | | | | |
|---|---|---|---|---|
| Total | 100 | 100 | 100 | 100 |
| Tni [° C.] | 75 | 76 | 75 | 72 |
| Tcn [° C.] | −23 | −45 | −50 | −57 |
| Δn | 0.103 | 0.105 | 0.110 | 0.120 |
| η [mPa · s] | 17.1 | 14.4 | 14.7 | 14.9 |
| γ1 [mPa · s] | 118 | 101 | 100 | 104 |
| Δε | −2.9 | −2.9 | −2.9 | −2.8 |
| K33 [pN] | 13.3 | 15.1 | 15.4 | 15.2 |
| γ1/K33 | 8.9 | 6.7 | 6.5 | 6.8 |

The liquid crystal compositions LC-1, LC-2, and LC-3 of the present invention each had a small viscosity (η), small rotational viscosity (γ₁), and large elastic constant (K₃₃); in addition, they had γ₁/K₃₃ of 6.7, 6.5, and 6.8, respectively, which were smaller than that of the liquid crystal composition LC-A as Comparative Example.

These liquid crystal compositions were individually used to produce liquid crystal display devices, and the response speed thereof was measured. The liquid crystal display devices using the LC-1, LC-2, and LC-3 showed sufficiently high response speed that was approximately 15 to 20% greater than that of the liquid crystal display device using the LC-A. In this case, the cell thickness was 3.3 μm, the alignment film used was JALS2096, and the response speed was measured under the following conditions of Von: 5 V, Voff: 1.0 V, measurement temperature: 20° C., and equipment used: DMS301 manufactured by AUTRONIC-MELCHERS GmbH.
The liquid crystal compositions were subjected to measurement of Tcn; the LC-1, LC-2, and LC-3 each had a sufficiently lower Tcn than the LC-A as Comparative Example. The liquid crystal compositions were subjected to measurement of a voltage holding ratio after UV exposure (VHR (UV); the LC-1, LC-2, LC-3 and LC-A each had a sufficiently high voltage holding ratio. In this case, the cell thickness was 6 μm, the alignment film used was AL-1051, and the VHR was measured under the following conditions of voltage: 1 V, frequency: 3 Hz, temperature: 60° C., and equipment used: VHR-1 manufactured by TOYO Corporation.

### Comparative Examples 2 and 3 and Example 4

Liquid crystal compositions LC-B (Comparative Example 2), LC-C(Comparative Example 3), and LC-4 (Example 4) were prepared; and the physical properties thereof were measured. Table 2 shows the components and physical properties of the liquid crystal compositions.

TABLE 2

| | | | Comparative | Comparative |
|---|---|---|---|---|
| | | Example 4 | Example 2 | Example 3 |
| | | LC-4 | LC-B | LC-C |
| 2-Cy-Cy-V1 | Formula (N2) | 25 | 25 | — |
| 3-Cy-Ph-Ph-2 | General Formula (N3) | 4 | — | 4 |
| 5-Cy-Ph-Ph-2 | General Formula (N3) | 6 | — | 6 |
| 3-Cy-Ph5-O2 | General Formula (II-B1) | 4 | 4 | 4 |
| 3-Ph-Ph5-O2 | General Formula (II-B2) | 4 | 4 | 4 |
| 2-Cy-Cy-Ph5-O1 | General Formula (II-B3) | 10 | 10 | 10 |
| 2-Cy-Cy-Ph5-O2 | General Formula (II-B3) | 10 | 10 | 10 |
| 3-Cy-Cy-Ph5-O2 | General Formula (II-B3) | 10 | 10 | 10 |
| 2-Cy-Ph-Ph5-O2 | General Formula (II-B4) | 3 | 3 | 3 |
| 3-Cy-Ph-Ph5-O3 | General Formula (II-B4) | 4 | 4 | 4 |
| 3-Ph-Ph-1 | General Formula (IV-3) | 1.5 | 1.5 | 1.5 |
| 5-Ph-Ph-1 | General Formula (IV-3) | 1.5 | 1.5 | 1.5 |
| 3-Cy-Cy-2 | General Formula (IV-1) | — | — | 25 |
| 3-Cy-Cy-4 | General Formula (IV-1) | 2 | 2 | 2 |
| 3-Cy-Cy-V | General Formula (IV-1) | 2 | 2 | 2 |
| 3-Cy-Cy-V1 | General Formula (IV-1) | 3 | 3 | 3 |
| 3-Cy-Cy-Ph-1 | General Formula (IV-5) | — | 4 | — |
| 3-Cy-Cy-Ph-3 | General Formula (IV-5) | — | 6 | — |
| 3-Ph-Ph5-Ph-1 | General Formula (V) | 5 | 5 | 5 |
| 3-Ph-Ph5-Ph-2 | General Formula (V) | 5 | 5 | 5 |

| | | | |
|---|---|---|---|
| Total | 100 | 100 | 100 |
| Tni [° C.] | 88.4 | 88.1 | 85.5 |
| Tcn [° C.] | −53 | −56 | −15 |
| Δn | 0.113 | 0.106 | 0.108 |
| η [mPa · s] | 21.1 | 21.4 | 21.3 |
| γ1 [mPa · s] | 129 | 127 | 124 |
| Δε | −2.5 | −2.5 | −2.5 |
| K33 [pN] | 14.2 | 13.8 | 12.6 |
| γ1/K33 | 9.1 | 9.2 | 9.8 |

The liquid crystal composition LC-4 of the present invention had a small viscosity (η), small rotational viscosity (γ₁), and large elastic constant (K₃₃); in addition, it had γ₁/K₃₃ of 9.1 that was remarkably smaller than that of the liquid crystal composition LC-C as Comparative Example.

The LC-C had a Tcn of −15° C. that was unpractical. The LC-B as Comparative Example had γ₁/K₃₃ of 9.2 but small Δn, which showed that this liquid crystal composition was unsatisfactory for achieving the objects of the present invention.

Consequently, the liquid crystal compositions of the present invention each had a sufficiently small viscosity (η), sufficiently small rotational viscosity (γ1), a large elastic constant (K₃₃), a high voltage holding ratio (VHR), and negative dielectric anisotropy (Δ∈) with a large absolute value without reductions in refractive index anisotropy (Δn) and nematic phase-isotropic liquid phase transition temperature (Tₙᵢ); hence, liquid crystal display devices of, for instance, a VA type, which used such liquid crystal compositions, had a quick response speed and excellent display quality with defective display being eliminated or reduced.

1. A liquid crystal composition comprising a first component that is a compound represented by Formula (N2), 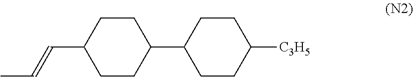
a second component that is at least one compound represented by General Formula (N3) 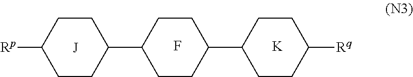
(where R^{p} and R^{q} each represent an alkyl group having 1 to 10 carbon atoms, an alkoxyl group having 1 to 10 carbon atoms, an alkenyl group having 2 to 10 carbon atoms, or an alkenyloxy group having 2 to 10 carbon atoms of which a —CH₂— or at least two —CH₂— not adjoining each other are each independently optionally substituted with —O— or —S— and of which one or more hydrogen atoms are each independently optionally substituted with a fluorine atom or a chlorine atom; a ring J represents a trans-1,4-cyclohexylene group, a 1,4-phenylene group, a 2-fluoro-1,4-phenylene group, a 3-fluoro-1,4-phenylene group, a 3,5-difluoro-1,4-phenylene group, a 2,3-difluoro-1,4-phenylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2,6-diyl group; and rings F and K each represent a 1,4-phenylene group of which a hydrogen atom is optionally substituted with a fluorine atom), and a third component that is at least one compound having a negative dielectric anisotropy (Δ∈) with an absolute value of greater than three.

2. The liquid crystal composition according to claim 1, wherein dielectric anisotropy (Δ∈) at 25° C. is in the range of −2.0 to −8.0, refractive index anisotropy (Δn) at 20° C. is in the range of 0.08 to 0.14, viscosity (η) at 20° C. is in the range of 10 to 30 mPa·S, rotational viscosity (γ₁) at 20° C. is in the range of 60 to 130 mPa·S, and nematic phase-isotropic liquid phase transition temperature (Tₙᵢ) is in the range of 60° C. to 120° C.

3. The liquid crystal composition according to any one of claim 1, wherein at least one compound selected from the group consisting of compounds represented by General Formulae (N3-3) and (N3-4) is used as the second component, 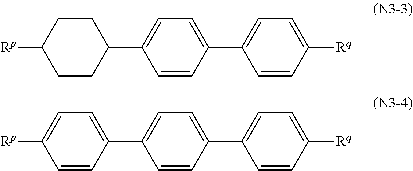
(where R^{p} and R^{q} have the same meanings as in claim 1, and a hydrogen atom of a 1,4-phenylene group is optionally substituted with a fluorine atom).

4. The liquid crystal composition according to claim 1, wherein the amount of the first component is from 3 to 40 mass %.

5. The liquid crystal composition according to claim 1, wherein the amount of the second component is from 3 to 40 mass %.

6. The liquid crystal composition according to claim 1, wherein at least one compound represented by General Formula (II) is used as the third component 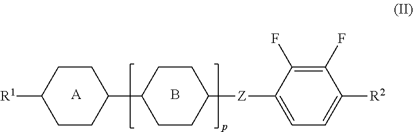
(where R¹ and R² each independently represent an alkyl group having 1 to 10 carbon atoms, an alkoxy group having 1 to 10 carbon atoms, an alkenyl group having 2 to 10 carbon atoms, or an alkenyloxy group having 2 to 10 carbon atoms of which one —CH₂— or at least two —CH₂— not adjoining each other are each independently optionally substituted with —O— or —S— and of which one or more hydrogen atoms are each independently optionally substituted with a fluorine atom or a chlorine atom; rings A and B each independently represent a trans-1,4-cyclohexylene group, a 1,4-phenylene group, a 2-fluoro-1,4-phenylene group, a 3-fluoro-1,4-phenylene group, a 3,5-difluoro-1,4-phenylene group, a 2,3-difluoro-1,4-phenylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2,6-diyl group; p represents 0, 1, or 2; in the case where p represents 2, the two rings B may be the same as or different from each other; Z represents —OCH₂—, —CH₂O—, —CF₂O—, —OCF₂—, —CH₂CH₂—, —CF₂CF₂—, or a single bond).

7. The liquid crystal composition according to claim 1, further comprising a fourth component that is at least one compound selected from the group consisting of compounds represented by General Formulae (IV-1) to (IV-5) 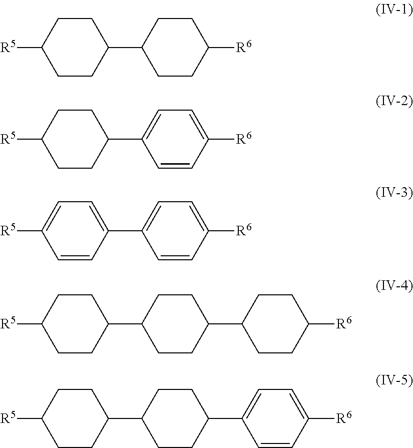
(where R⁵ represents an alkyl group having 1 to 5 carbon atoms or an alkenyl group having 2 to 5 carbon atoms; R⁶ represents an alkyl group having 1 to 5 carbon atoms, an alkoxyl group having 1 to 5 carbon atoms, an alkenyl group having 2 to 5 carbon atoms, or an alkenyloxy group having 2 to 5 carbon atoms of which one —CH₂— or at least two —CH₂— not adjoining each other are each independently optionally substituted with —O— or —S— and of which one or more hydrogen atoms are each independently optionally substituted with a fluorine atom; and the compound represented by General Formula (IV-1) excludes compounds corresponding to the compound represented by Formula (N2)).

8. The liquid crystal composition according to claim 1, further comprising an additional component that is at least one compound represented by General Formula (V) 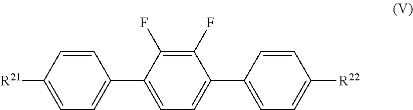
(where R²¹ and R²² each independently represent an alkyl group having 1 to 8 carbon atoms, an alkoxyl group having 1 to 8 carbon atoms, an alkenyl group having 2 to 8 carbon atoms, or an alkenyloxyl group having 2 to 8 carbon atoms of which one —CH₂— or at least two —CH₂— not adjoining each other are each independently optionally substituted with —O— or —S— and of which one or more hydrogen atoms are each independently optionally substituted with a fluorine atom).

9. The liquid crystal composition according to claim 1, further comprising at least one polymerizable compound.

10. The liquid crystal composition according to claim 9, wherein the polymerizable compound is at least one polymerizable compound represented by General Formula (M) 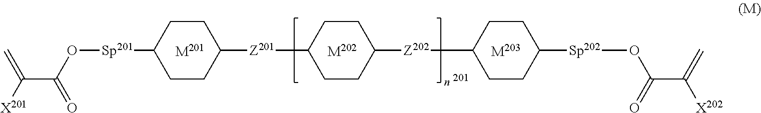
(where X²⁰¹ and X²⁰² each independently represent a hydrogen atom, a methyl group, or a —CF₃ group; Sp²⁰¹ and Sp²⁰² each independently represent a single bond, an alkylene group having 1 to 8 carbon atoms, or —O—(CH₂)ₛ— (where s represents an integer from 2 to 7, and the oxygen atom is bonded to a ring); rings M²⁰¹, M²⁰², and M²⁰³ each independently represent a trans-1,4-cyclohexylene group (of which one —CH₂— or at least two —CH₂— not adjoining each other are optionally substituted with —O— or —S—), a 1,4-phenylene group (of which one —CH═ or at least two —CH═ not adjoining each other are optionally substituted with —N═), a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2,6-diyl group; independently in each of these groups, a hydrogen atom is optionally substituted with a fluorine atom, a —CF₃ group, an alkyl group having 1 to 10 carbon atoms, an alkoxyl group having 1 to 10 carbon atoms, or any of the following structures represented by Formulae (R-1) to (R-15) 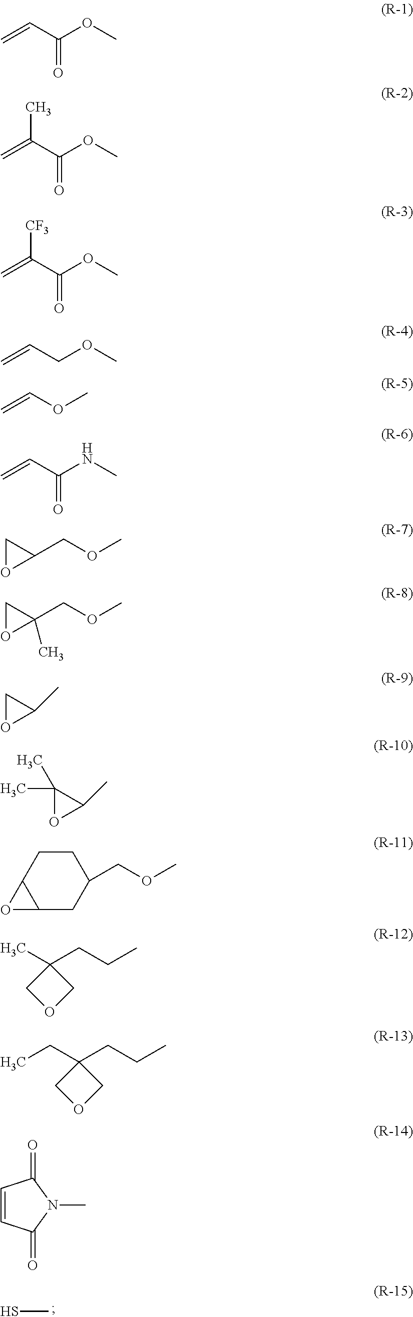
Z²⁰¹ and Z²⁰² each independently represent —OCH₂—, —CH₂O—, —COO—, —OCO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CY¹═CY²— (where Y¹ and Y² each independently represent a fluorine atom or a hydrogen atom), —C≡C—, or a single bond; n²⁰¹ represents 0, 1, or 2; and in the case where the ring M²⁰² and Z²⁰² are multiple, the multiple rings M²⁰² may be the same as or different from each other, and the multiple Z²⁰²'s may be the same as or different from each other.

11. A liquid crystal display device comprising the liquid crystal composition according to claim 1.

12. An active-matrix liquid crystal display device comprising the liquid crystal composition according to claim 1.

13. A liquid crystal display device of any of VA, PSA, PSVA, IPS, and ECB modes, the device comprising the liquid crystal composition according to claim 1.
